(19) United States
(12) Patent Application Publication
(10) Pub. No.: US 2012/0036006 A1
(43) Pub. Date: Feb. 9, 2012

(54) ADVERTISING MEDIA TRACKING

(75) Inventor: Joseph L. Mauro, Jersey Shore, PA (US)

(73) Assignee: ADTRAK360, Williamsport, PA (US)

(21) Appl. No.: 13/188,784

(22) Filed: Jul. 22, 2011

Related U.S. Application Data
(60) Provisional application No. 61/366,804, filed on Jul. 22, 2010.

(51) Int. Cl. G06Q 30/02

(52) U.S. Cl. 705/14.42

(57) ABSTRACT

A system tracks the effectiveness of advertising across both on-line and off-line media. Users define advertisements that are part of an advertising campaign and include in the definition tracking identifiers such as telephone numbers and URL's. The system tracks inputs that are subsequently received in response to and generated by the various advertisements. The inputs contain tracking identifier information. The system correlates the tracking identifier information from the received user inputs with tracking identifier information entered upon definition of advertisements in the system. Thereafter, the system generates reports that illustrate the relative effectiveness of the advertisements in driving inputs.

### CROSS-REFERENCE TO RELATED APPLICATIONS

The present application claims priority to U.S. Provisional Patent Application No. 61/366,804 filed on Jul. 22, 2010, the contents of which are hereby incorporated herein by reference in their entirety.

### BACKGROUND

Advertisers have numerous different media types at their disposal in which to place advertisements. For example, advertisers may select to advertise in traditional print media such as newspapers, magazines, and printed periodicals, etc. Advertisers may also advertise using traditional broadcast media such as, for example, radio and broadcast television. In recent years, a new set of advertising media types have arisen such as, for example: cable television; satellite radio; wireless cell phone-enabled media such as short messaging service (SMS/MMS) and instant messaging; and Internet-enabled communications media such as, for example, web pages, email, and social networking. As technology advances, even more media types are likely to be developed.

Advertisers may choose to place advertisements in any combination of the numerous different media types. Accordingly, an advertiser may run advertisements in a traditional off-line media type while simultaneously running advertisements in on-line media. For example, an advertiser may simultaneously run ads in, for example, newspapers, web pages, and broadcast radio. Similarly, an advertiser may simultaneously run ads on a cable television channels, distribute advertisements through mass electronic mailings, and published advertisements on billboards and in local newspapers.

While advertisers may enjoy the options that the various advertising media types provide, advertisers are faced with the practical reality that it is difficult to know the benefit derived from any particular advertisement media type. In other words, using existing technologies and techniques, an advertiser may not be able to quantify the effect that a particular advertisement may have had in driving customers to the desired activity.

### SUMMARY

Applicants disclose systems and methods for tracking the effectiveness of advertising across both on-line media, i.e., communicated via an Internet communications link, and off-line media, i.e., not communicated via an Internet communications link. On-line media often involves media that is automated and electronically interactive. Websites, mobile websites, social media, instant messaging and similar messaging types are all electronically interactive media that may be considered on-line media. Users may employ the disclosed systems to define advertisements that are part of an advertising campaign. For example, the user may input information regarding an advertisement that is scheduled to run in a newspaper, as well as an advertisement that is scheduled to run on-line at various websites. The system tracks inputs that are subsequently received in response to and generated by the various advertisements. For example, the system may track telephone calls, web page accesses, XMS messages, and/or mobile web activities that are driven by the identified advertisements. Thereafter, the system generates reports that illustrate the effectiveness of the advertisements in driving inputs. In an example scenario, the system may generate reports that identify the number of telephone calls that were received and the number of web site access that were made in response to a first advertisement in a particular newspaper, as well as the number of telephone calls that were received and web site accesses that were made in response to a second advertisement placed at a website. The juxtaposition of the data for the two advertisements, one online and one offline, allows for the operator to evaluate the relative effectiveness of the two advertisements.

In an example embodiment, the disclosed systems may be used to track and report on the effectiveness of advertisements at different levels of a hierarchical grouping of organizations. For example, advertisements may be tracked for a particular operating organization such as, for example, a local car dealer franchise. The local car dealer franchise may be a member of a regional affiliation of car dealerships. Still further the regional affiliation of car dealerships may report to a national organization and/or to the car manufacturer. Thus, a hierarchical relationship exists as between the local dealerships, the regional affiliation, and the national groups. The disclosed systems and methods may be employed to track the effectiveness of advertising at each level of the hierarchy. For example, the effectiveness of advertisements for a particular car dealership may be tracked. The tracking data for the effectiveness of the car dealer's advertisements may be grouped with data for other car dealers so as to provide reporting on the effectiveness of advertisements at a regional level as well. Still further, data may be aggregated so as to report at a national level as to the effectiveness of advertisements from a national perspective.

In an example embodiment of the disclosed systems, user inputs are received that define advertisements that an advertiser plans to run. The advertisements may be identified as belonging to a particular advertising campaign. For example, two advertisements may be identified as belonging to a particular rebate campaign. In an example scenario, the advertisements may be identified as belonging to a “$500 cash back” campaign for selling cars.

In connection with defining the advertisements, the user enters information about the particular media type of each advertisement. For example, the user enters information about whether the advertisement will appear in a printed publication, distributed via email, posted on a web page, or any other advertising media type. The user then assigns tracking identifiers to each of the advertisements. The tracking identifiers may be any information that may be used to correlate inputs that are subsequently received with the particular advertisement. For example, a tracking identifier may be a telephone number, a Web address, a bar code, a QR code, a phone identifier, or any other information that can be used to correlate subsequent inputs to the advertisement. In an example scenario, a telephone number may be assigned to a particular advertisement, with the telephone number being one that appears in the advertisement and identified for viewers of the advertisement to call. Similarly, a web address or URL may be identified as a tracking identifier, where the web address or URL is included in the advertisement and identified for viewers of the advertisement to access. One or more tracking identifiers may be specified for each advertisement. For example, both a telephone number and a web address may be associated with a single advertisement.

When the advertisements run, whether it be in a magazine, on a web page, or otherwise, the expectation is that some of the persons who are exposed to the advertisements will respond to the advertisements. In particular, the expectation is that persons exposed to advertisements that include a telephone number will call the telephone number to obtain more information about the subject of the advertisement. Likewise, persons exposed to an advertisement that includes a web address, a URL, and/or a link to a URL may access the web address or URL to obtain more information about the subject of the advertisement.

The disclosed system uses the tracking identifiers, i.e., the telephone numbers and the web addresses, to track inputs, which may be referred to as leads, associated with the particular advertisements. In an example embodiment, a plurality of inputs or leads may be received that are associated with one or more of the tracking identifiers that were specified for particular advertisements. For example, calls may be made to a particular telephone number that was defined in the system as being associated with a particular advertisement. Similarly, accesses may be made to particular web pages or URL's that have been designated as being associated with a particular advertisement. These inputs or leads are received and identified as being associated with a particular advertisement based upon the tracking identifier. Information regarding the inputs and the association with a particular advertisement are stored for later compilation and analysis.

In an example embodiment, the stored information regarding the inputs that have been received and the association with particular advertisements are used to illustrate the effectiveness of the various media advertisements. For example, the system analyzes the data and generates reports that specify the number of telephone calls that were received in response to a particular advertisement. Likewise, the system may generate reports that specify the number of web accesses that were received in response to a particular advertisement. The system allows for reviewing data for multiple different advertisements simultaneously and thereby allows for comparing the effectiveness of the different media types. Furthermore, the data may be rolled up to illustrate the effectiveness of media within a hierarchical organization.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

FIG. 1 is a block diagram of an illustrative computing arrangement in which aspects of the subject matter described herein may be implemented.

FIG. 2 is a block diagram illustrating functional components of an illustrative computing arrangement.

FIG. 3 is a block diagram depicting processing in an illustrative system for tracking advertisements.

FIG. 4 is a block diagram depicting processing in an illustrative system for tracking advertisements.

FIG. 5 is a block diagram depicting processing in an illustrative system for tracking advertisements.

FIGS. 6A-6F depict example user interfaces with reporting data that may be generated in an illustrative system for tracking advertisements.

FIG. 7 is a block diagram of a computing environment with which aspects of the subject matter described herein may be deployed.

### DETAILED DESCRIPTION OF ILLUSTRATIVE EMBODIMENTS

Overview

Advertisers have numerous different media types at their disposal in which to place advertisements. For example, advertisers may select to advertise in traditional print media such as newspapers, magazines, and printed periodicals, etc. While advertisers enjoy the options that all of the various advertising media types provide, advertisers are also faced with the practical reality that using existing methodologies it is difficult to know the benefit derived from any particular advertisement media type. In other words, using existing technologies and techniques, an advertiser may not be able to quantify the relative effect that a particular advertisement may have had in driving customers to the desired activity.

Applicants disclose systems and methods for tracking the effectiveness of advertising across both on-line and off-line media. Users may employ the disclosed systems to define advertisements that are part of an advertising campaign. For example, the user may input information regarding an advertisement that is scheduled to run in a newspaper, as well as an advertisement that is scheduled to run on-line at various websites. The system tracks inputs that are subsequently received in response to and generated by the various advertisements. Thereafter, the system may be used to generate reports that illustrate the relative effectiveness of the advertisements in driving inputs.

Example Computing Arrangement

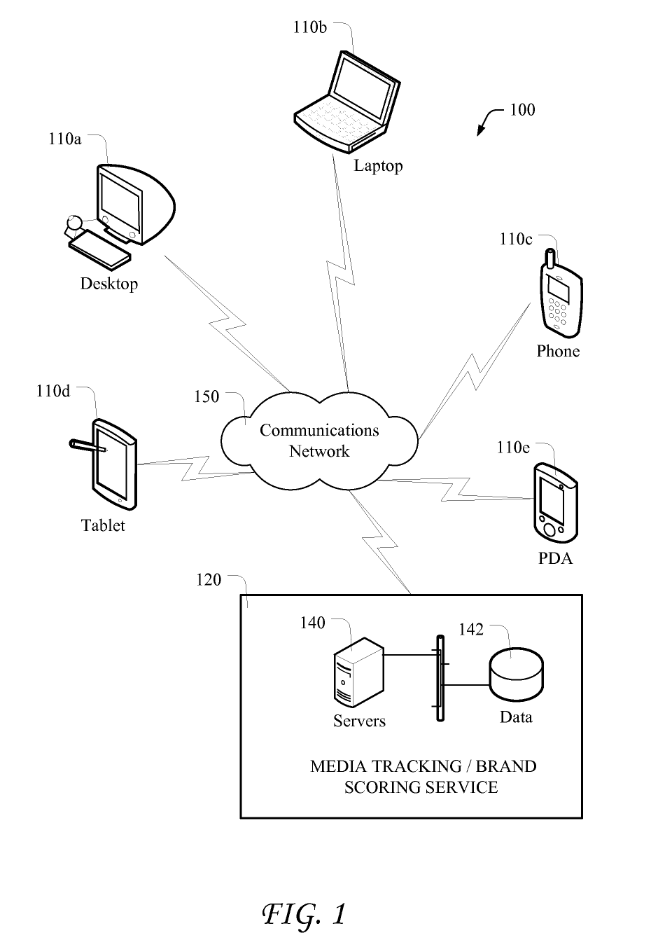

FIG. 1 illustrates an exemplary computing network 100 suitable for advertisement tracking. Media tracking service 120 offers a number of different functions including, for example, defining advertising campaigns, assigning tracking identifiers to advertisements, receiving inputs generated by the advertisements, correlating the inputs with the advertisements using the tracking identifiers, and presenting data regarding the effectiveness of the various advertisements. Users employ computing devices 110a-e to interface with media tracking service 120 via communications network 150. Computing devices 110a-e may be used to interface with tracking service 120 in order to identify in the system the advertisements that are scheduled to run. In some instances, devices such as 110a-e may be employed to forward data relating to inputs such as telephone calls and web page accesses that were generated in response to the various advertisements. Still further, users may use devices such as 110a-e to access reports that illustrate the effectiveness of the advertisements.

In an exemplary environment, media tracking service 120 provides various functionalities associated with tracking the effectiveness of advertisements. For example, media tracking service 120 may receive inputs defining advertisements and advertising campaigns, receive data gathered in response to the advertisements, and report information regarding the effectiveness of the various advertisements. The media tracking functionality as described herein is performed on computing servers 140 which communicate with data stores 142, which may be accessed locally or remotely. Data stores 142 maintain any data that may be needed to support the functionality described herein. For example, data stores 142 may comprise data regarding scheduled advertisements including any tracking identifiers such as phone numbers and web addresses, data regarding inputs or leads received in response to advertisements, and data resulting from any analysis of the input data. Computing servers 140 provide functionality to receive inputs defining advertising campaigns, receive data regarding inputs or leads responding to advertisements, analyze the data, and report on the effectiveness of the advertisements. Any number of servers 140 and data stores 142 may be used to provide a media tracking service as described herein.

Media tracking service 120 is accessible via communications network 150. Communications network 150 may be any type of network that is suitable for providing communications between computing devices 110a-e and service 120. Moreover, communications network 150 may comprise a combination of discrete networks which may use different technologies. For example, communications network 150 may comprise local area networks (LANs), wide area networks (WAN's), cellular networks, or combinations thereof. Communications network 150 may comprise wireless, wireline, or combination thereof. In an exemplary embodiment, communications network 150 comprises the Internet and may additionally comprise any networks adapted to communicate with the Internet. In one exemplary embodiment, communications network 150 may comprise a network that enables passengers on a commercial airline to communicate with servers 140.

Persons that wish to define advertising campaigns in the media tracking service 120 and to access data regarding the effectiveness of those advertising campaigns may do so using computing devices 110a-e. Likewise, data associated with inputs received in response to the advertisements may be forwarded to service 120 via systems such as 110a-e. Computing devices 110a-e may be any type of device that is operable to communicate with service 120. For example, computing devices 110a-e may be desktop computers, laptop computers, wireless phones, personal digital assistants, tablet computers, media players, etc. While only five devices are illustrated in FIG. 1, it is understood that service 120 may be accessed via any number of computing devices 110a-e.

Computing arrangement 100 may employ a host of network topologies such as client/server, peer-to-peer, or hybrid architectures. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computing device, such as one of devices 110a-e that accesses shared network resources provided by another computer (i.e., a server). A server, such as device 140, is typically a remote computer system accessible over a remote network such as the Internet. The client process may be active in a first computer system, and the server process may be active in a second computer system, communicating with one another over a communications medium and allowing multiple clients to take advantage of the information-gathering capabilities of the server.

Clients and servers communicate with one another utilizing the functionality provided by a protocol layer. For example, Hypertext-Transfer Protocol (HTTP) is a common protocol that is used in conjunction with the World Wide Web (WWW) or, simply, the “Web.” Typically, a computer network address such as a Uniform Resource Locator (URL) or an Internet Protocol (IP) address is used to identify the server or client computers to each other. Communication among computing devices is provided over a communications medium. In particular, the client and server may be coupled to one another via TCP/IP connections for high-capacity communication.

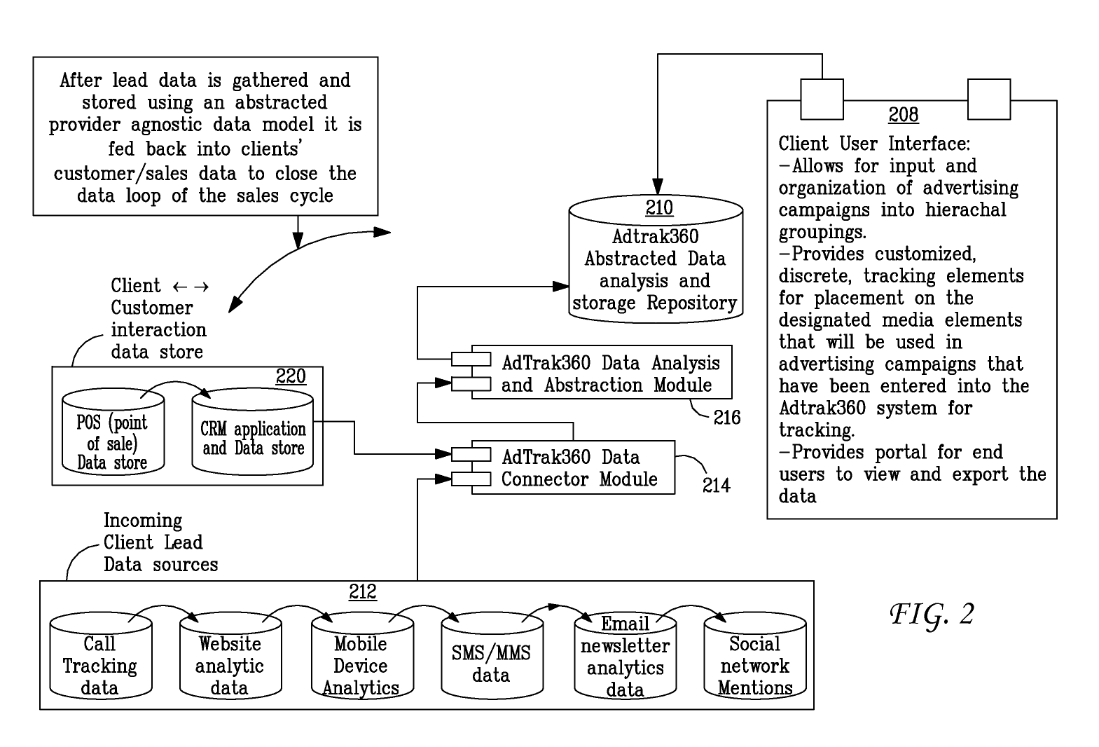

FIG. 2 depicts a block diagram illustrating exemplary logical components of an illustrative service 120 for tracking media effectiveness. As shown at block 208, the system is adapted to provide a client user interface. For example, service 120 may be adapted to serve web pages that provide an interface for interacting with service 120. The user interface may allow users to input and organize advertising campaigns into hierarchical groupings. The user interface allows for users to enter customized, discrete, tracking identifiers such as phone numbers and web addresses that may be paced on the media elements that may be used in advertising campaigns that have been entered into the system. Still further the user interface allows users to access reports that illustrate the effectiveness of the various advertisements in an advertising campaign.

Illustrative service 120 comprises or has access to data store or database 210. Data store 210 comprises any information needed to support the functionality described herein. In an illustrative embodiment, for example, data store 120 may comprise information regarding the advertisements and the advertising campaigns that have been identified in the system, data regarding inputs that have been received in response to the various advertising campaigns, and data relating to and generated by analysis of the data.

Advertising lead interface 212 operates to receive data regarding any inputs or leads that were received in response to the advertisements that are being tracked by service 120. The leads may be received from any type of source and relate to any type of advertising media. In the example embodiment of FIG. 2, lead interface 212 interfaces with sources of call tracking data, website data, mobile device data, SMS/MMS data, email data, and social network data. In an example embodiment, this data may correspond to phone calls that are placed to phone numbers that have been identified as tracking identifiers for previously defined advertisements. Likewise, the data may correspond to accesses to web pages and URL's that were previously identified as tracking identifiers for advertising campaigns entered into the system.

The data that is received from interface 212 is processed by data connector module 214 and data analysis and abstraction module 216 before being stored in data store 210. Data connector module 214 operates to receive lead data from lead interface 212 and other data sources such as customer data source 220.

Data analysis and abstraction module 216 performs analysis and calculations on the data that is received into the system including the lead data from interface 212. For example, module 216 may identify which advertisements each of the leads corresponds to. In a particular embodiment, module 216 identifies the media tracking identifiers included with the data received over interface 212 and uses those identifiers to query data store 210 in order to determine the particular advertisement that each of the leads corresponds to. For example, where the lead data relates to a telephone call, module 216 uses the telephone number at which the call was received to search database 210 in order to identify the advertisement to which the call corresponds. Likewise, where the lead data relates to an input received at a particular web page, the web page URL may be used to search database 210 and identify the advertisements to which the input corresponds. The analyzed data is stored in database 210.

Customer data store 220 comprises information regarding actual sales that have been made. In an example embodiment, customer data store 220 may comprise data relating to the location of the sales, the dates for the sales, and any other corresponding data. In some embodiments, the data may also identify advertisements that the sale may have been driven by. For example, if a sale was ultimately in response to a telephone call placed to a telephone number identified in a particular advertisement, the information may be identified in data store 220. In an example embodiment of service 120, data regarding advertisements and sales leads that is collected by service 120 may be communicated from data store 210 via module 214 to customer data store 220. For example, data regarding the advertisements that were run at various times and the user inputs or leads that were generated in response to those advertisements may be communicated from data store 210 to customer data 220 where the data may be stored in a customer relations management tool for further analysis.

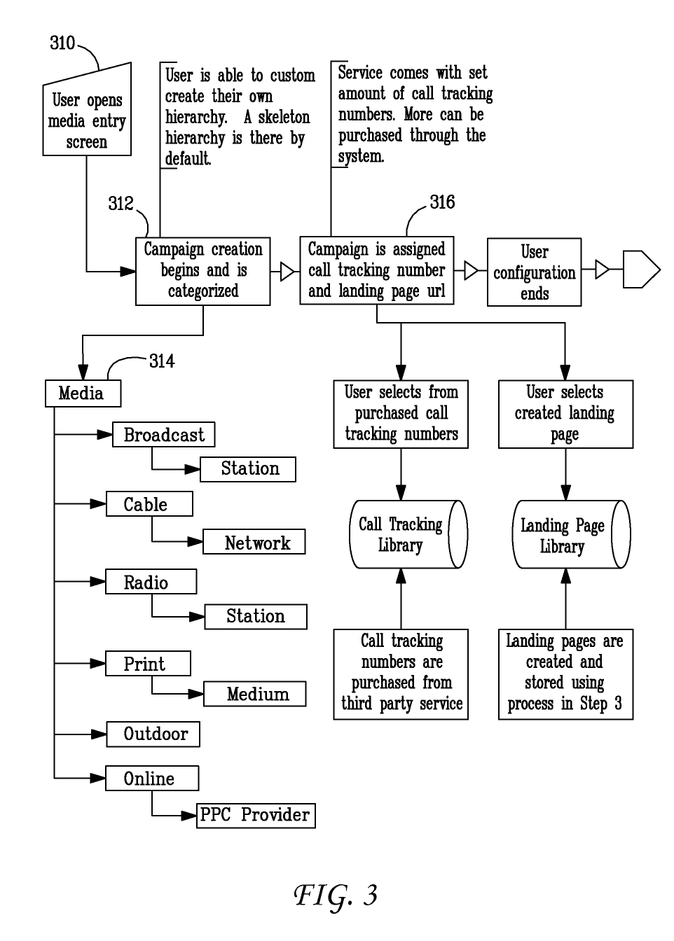

FIGS. 3-5 depict a block diagram illustrating data processing flows in an example embodiment of service 120. Referring to FIG. 3, at block 310 service 120 receives a user request to access the functionality of the service. The user request and subsequent requests from the user may be received, for example, from any of devices 110a-e.

At block 312, service 120 receives inputs from the user identifying an advertising campaign. In an example embodiment, service 120 receives inputs that may either select an existing advertising campaign that has been created in service 120 or define a new campaign. Creating or defining a new campaign comprises receiving inputs specifying a name for a campaign and any other relevant information. For example, the campaign may be associated with a particular organization or hierarchy of organizations. Financial information regarding the campaign such as the cost of the campaign may be entered. Still further, dates and duration may be specified for the campaign. The information relating to the campaign is stored in a data store such as data store 210.

After an existing campaign has been selected and/or a new campaign has been added to the system, user inputs are received specifying the details of the particular advertisements that are comprised as part of the campaign. For example, inputs may be received that specify a particular advertisement is scheduled to be run in a particular media type during a particular period of time and has a particular cost associated therewith. In the example embodiment corresponding to FIG. 3, media types that may be specified for a campaign comprise: broadcast television; cable television; radio (broadcast and/or satellite); print media such as newspapers, magazines, etc.; outdoor media such as billboards and physical kiosks; and online media such as, for example, web sites, email, social media, etc. It should be understood, however, that any media type may be specified for a particular advertisement including those not specifically listed. For each advertisement and the media type specified for the advertisement, inputs specifying various related information may be received. For example, for an advertisement that is to be run on a broadcast television, the particular channel and dates and times that the advertisement will run may be specified. The system may provide a calendar functionality by which to enter date and time information for advertisements. Similar information may be received for specifying an advertisement to be run on cable or on radio media. For print media, information defining the name of the publication and the dates in which the advertisement will appear may be entered into the system. For an outdoor billboard, the location of the billboard and the dates for which the advertisement will be presented may be entered. With respect to online media, any relevant administrative information may be entered including, for example, any URL's and/or web sites upon which the advertisement may be displayed. In an example embodiment, the monetary budget associated with particular advertisements may also be entered into the system. This allows for later calculating the return on the advertising investment. The information that is entered relating to the advertisement is stored in a data store such as data store 210.

In an example embodiment, and as depicted at block 316, service 120 receives tracking identifiers in connection with defining advertisements that are comprised in a campaign. Tracking identifiers may be any information that is associated with an advertisement and that is displayed or otherwise presented as part of the advertisement and which may be used to track actions from consumers in response to the advertisement. For example, telephone numbers, web page URL's, bar codes, QR codes, device identifiers may be tracking identifiers that are associated with advertisements. Accordingly, in an example embodiment, user inputs defining an advertisement in the system also specify a telephone number, a URL, both a telephone number and URL, or any other identifier. In an example scenario, user inputs are received specifying a first telephone number and a first URL as identifiers for a first advertisement. Similarly, inputs are received specifying a second telephone number and a second URL as identifiers for a second advertisement. The identifiers are stored in association with the advertisement data to which they correspond in data store 210. Subsequently, when the advertisements are run either in an off-line media such as a paper or billboard or in an on-line media such as on a website, the advertisements include the tracking identifiers. For example, a telephone number that has been designated as a tracking identifier may be printed as part of the advertisement in a magazine or included as part of the voice broadcast of a radio advertisement. When that telephone number is then called by persons that were in the audience of the advertisement, it is possible to track the call to the particular advertisement. Web addresses and URL's are handled in a similar manner. The tracking identifiers are placed on the advertisements and then used later in processing of user inputs or leads to resolve which sales leads may have been generated by which advertisements.

In an example embodiment, previously developed tracking identifiers such as phone numbers and web addresses may be made available to users that are specifying an advertising campaign. For example, a database of available telephone numbers that may be assigned to advertisements and used as tracking identifiers may be made available to users. Similarly, a database of available URL's or landing web page identifiers that may be assigned to advertisements and used as tracking numbers may be made available to users. Users may then select these previously generated tracking identifiers to be associated with an advertisement that they are defining in the system. When an advertising campaign is complete, identifiers such as phone numbers or web addresses may be returned to the database for use with future advertisements.

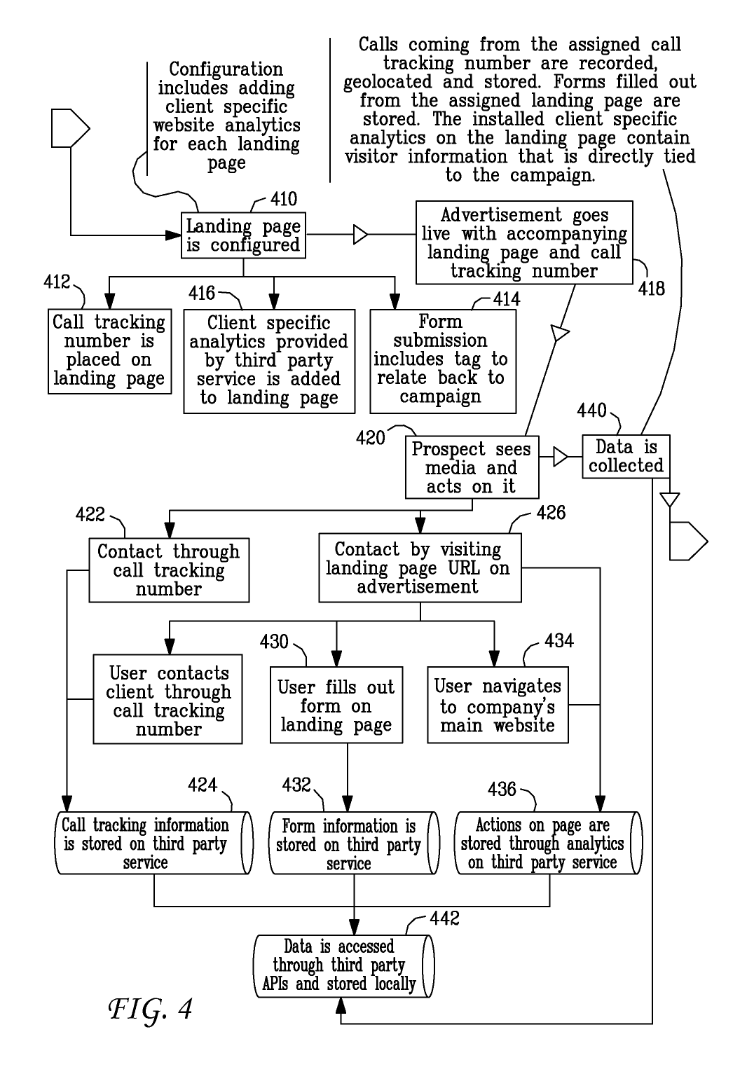

Referring to FIG. 4, in the instance wherein a URL has been identified as a tracking identifier, at block 410, a landing page corresponding to the URL may be configured. For example, and as shown at block 412, a web page may be created to display a telephone number that has been designated as a call tracking number for the advertisement. Similarly, and as shown at block 414, where the web page is configured to generate a form that may be completed by a user, the form may comprise an identifier such as a web page address or telephone number so that when the form is submitted, it may be discerned to which advertisement the input corresponds. Furthermore, where any web analytics is desired to be performed for a web page, at block 416, it may be associated with the web page. Data may be interpreted through the analytic program and the data run through an algorithm to plot and display website visitation in a real time format. As discussed below, the system may subsequently be used to provide an enumeration of the actual website visitors and the associated media responsible for the visitors.

As shown at block 418, the scheduled advertisements go live with the corresponding tracking identifiers such as telephone numbers and web page addresses. For example, an advertisement that was identified in service 120 may be published in the newspaper and contain the telephone number and web address that were identified in the system as being identifiers for the advertisement. Similarly, an advertisement that was identified in service may go on-line at a particular web site and contain the telephone number and web address that were identified in the system as being identifiers for the advertisement. In another embodiment, a business card may be handed out that comprises a telephone number and/or web address that were identified in the system as being identifiers for the business card advertisement. In another embodiment, a mobile web site may comprise a URL or link to a URL that has been identified as an advertisement identifier. It is envisioned that any type of activity or media that may be the subject of advertising may be used with the systems and methods disclosed herein including all forms of electronic messaging and wireless device communications. As noted at block 420, persons from the pool of intended recipients of the advertisements see and/or hear the advertisements.

Referring to block 422, a person that was the recipient of a particular advertisement may call the telephone number that was designated as a tracking identifier for the advertisement. The telephone number may be manned by representatives of the advertiser who placed the advertisement. The call to the telephone number and any information regarding the call may be captured and stored. For example, the time and date of the call may be recorded. In an embodiment, all or a portion of the telephone call may be recorded and thereafter subject to further review and analysis. At block 424, information relating to the call including its call tracking identifier and related information is stored for further analysis.

As shown at block 426, a person that was the recipient of a particular advertisement may access a particular web site or URL that was designated as a tracking identifier for the advertisement. The URL may correspond to a landing page that was specially formatted for use with the advertisement. The URL may correspond to a previously existing website. As shown at block 430, a user may complete an on-line form at the URL/website. The form contains the tracking identifier, i.e., the URL, so that when the completed form is submitted it can be clearly associated with the advertisement with which the tracking identifier is associated. At block 432, any information relating to the access to the tracking identifier and any forms that may have been submitted having the tracking identifier is stored for later retrieval and analysis.

Referring to bock 434, a URL that is being used as a tracking identifier may correspond to a particular website such as, for example a company's website. When the user accesses the website using the URL, and as shown at block 436, the user's actions on the page may be recorded and stored. For example the links that the user clicks on may be recorded and the information stored. This may be performed, for example, by an analytics program.

At block 440, the data regarding the user inputs or leads that were received in response to the advertisements is collected at service 120. For example, service 120 may receive the data through lead data interface 212. Collecting the data may involve receiving the data through one or more API's as noted at block 442. In connection with receiving the data, service 120 may perform analysis on the data. For example, for each of the inputs or leads that were received, the corresponding advertisement and advertising campaign are identified. For example, a first input or lead may have been generated as a result of a telephone call to a particular telephone number. Where the telephone number is a tracking identifier, service 120 identifies that the particular input was generated as a result of a call to the particular number and stores information identifying a relationship between the input and the advertisement for which the particular phone number serves as a tracking identifier. For other inputs that were received at a particular URL that was identified as a tracking identifier, service 120 associates the inputs as having been generated in connection with or in response to a particular advertisement for which the particular URL serves as a tracking identifier. Any related information that was collected for the lead or user input data is stored as well. Accordingly, information such as the date and time of the input may be stored. Other information such as any voice recordings or information regarding durations of calls may also be stored. Likewise any web analytics that may have been gathered relating to the lead may be stored

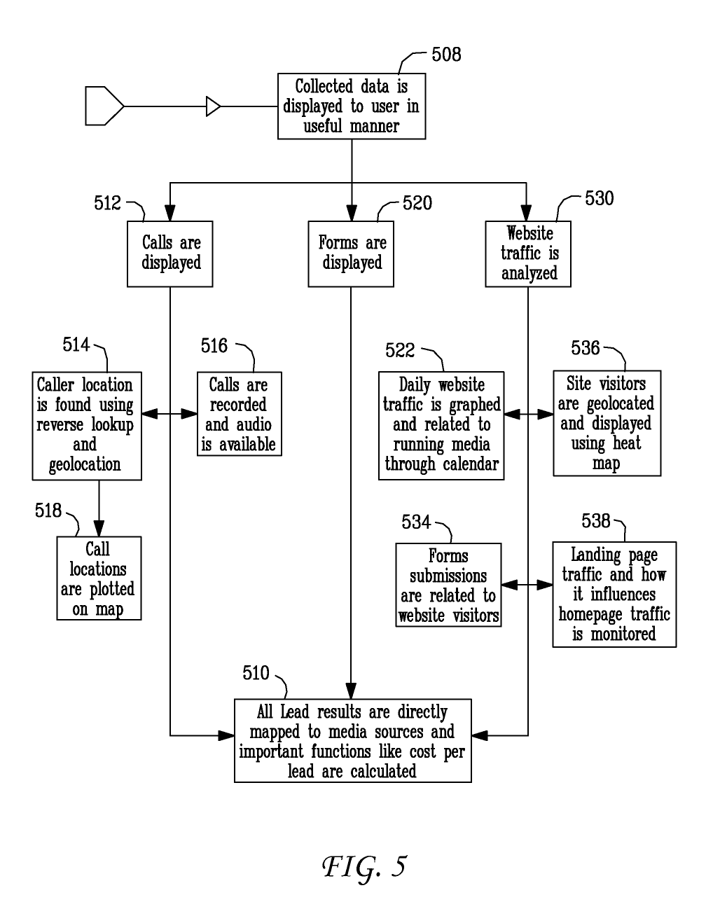

Referring to FIG. 5, various activities related to providing data illustrative of the effectiveness of the advertisements are depicted. As shown at block 508, data related to leads or user inputs that were generated in response to advertisements is analyzed and presented to users. As shown at box 512, data relating to inputs or leads associated with calls to telephone numbers that are identified as tracking identifiers may be analyzed and displayed. As illustrated at block 514, the analysis and display of data relating to lead data generated from calls may involve identifying the location of the caller. This information may be gathered through any suitable means including, for example, reverse lookup and geo-location. In some instances, and as represented by block 518, the location from which a call originated may be depicted on a geographic map. As shown at block 516, in some instances the calls are recorded and the audio made available in connection with the reporting.

As shown at block 520, information that was collected using a web form associated with a particular URL or web address may be analyzed and displayed. For example, the number of forms associated with a particular advertisement may be calculated. Similarly, the information entered on the form may be analyzed and prepared for reporting.

As shown at block 530, information that was collected relating to a website associated with a particular URL may be analyzed and presented. For example, and as shown at blocks 532, 534, 536, and 538, the location of the persons that were driven to a particular website URL by an advertisement may be derived. Furthermore, the form submissions that are made by persons driven to the particular site may be analyzed and data extracted. Still further, the daily website traffic generated by the URL that is a tracking identifier may be analyzed and reported upon.

Service 120 may use statistics to determine returns on marketing investment for media placements. The return may include visitors to a landing page and the website in general; calls received and forms submitted; landing page conversion rates which are the equation of how many visitors arrived at web based landing page verses how many took an action; and cost per lead. In an example embodiment of the disclosed systems, advertisement expenditures on each media may be directly related to the corresponding calendar schedule, amount of money spent, tracking numbers, URLs and the actions taken by prospects or leads.

An exemplary embodiment may give merchants an exact accounting of their advertisement budget in one easy to use console. With a series of assigned downstream analytical tools, e.g., call tracking and landing pages, for example, an exemplary embodiment of the disclosed system may measure each media's direct effectiveness on brick and mortar sales in concert with website traffic. An exemplary embodiment may automatically calculate cost per lead for every media placed, which may prove valuable with so many advertising choices facing today's business owner. An exemplary embodiment may implement open architecture so as to not only plug into today's marketing options, but also all future platforms including mobile and social media.

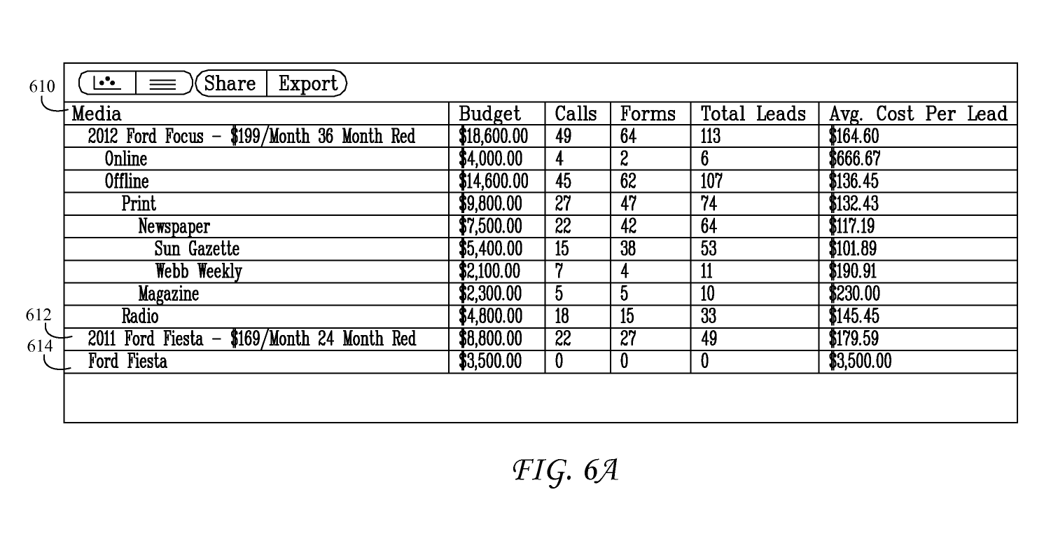

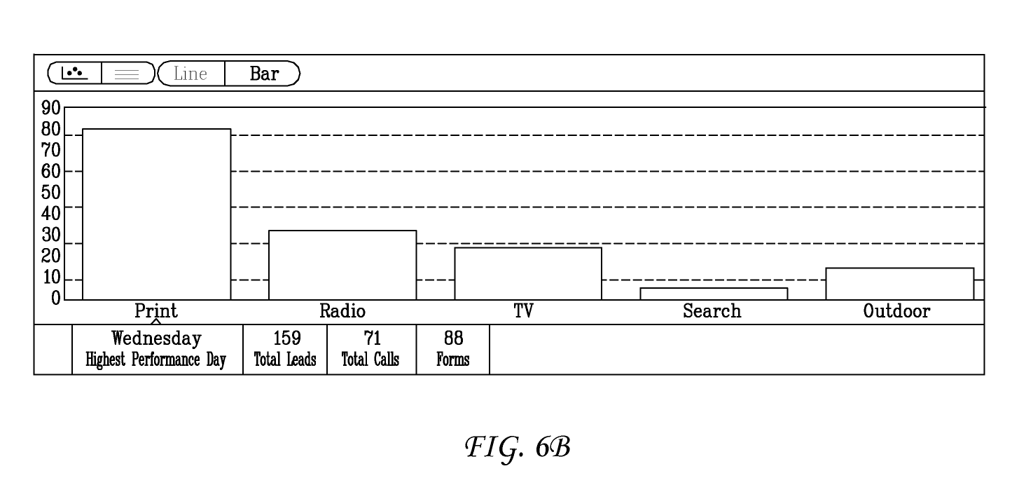

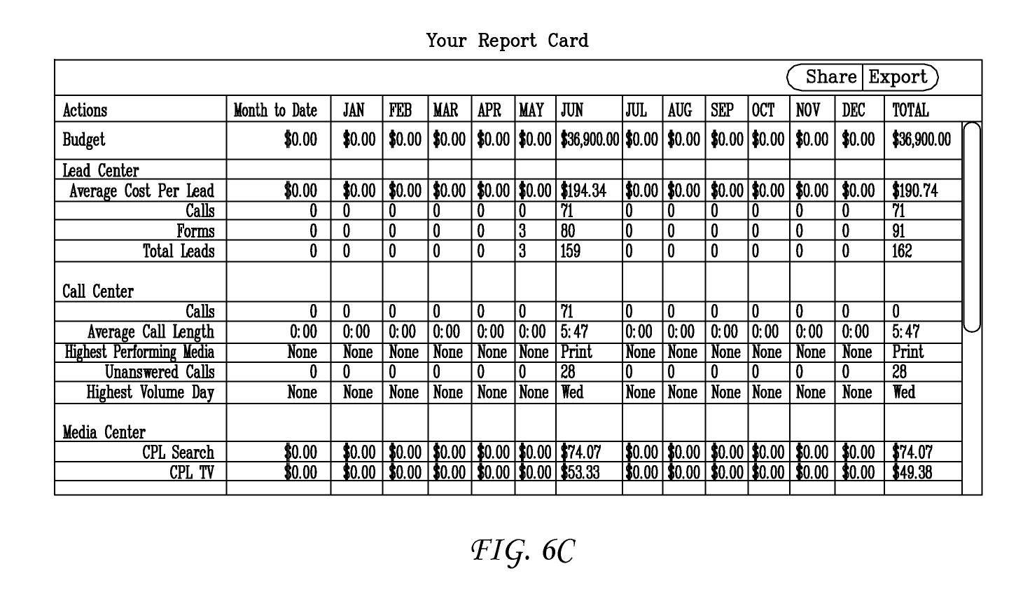

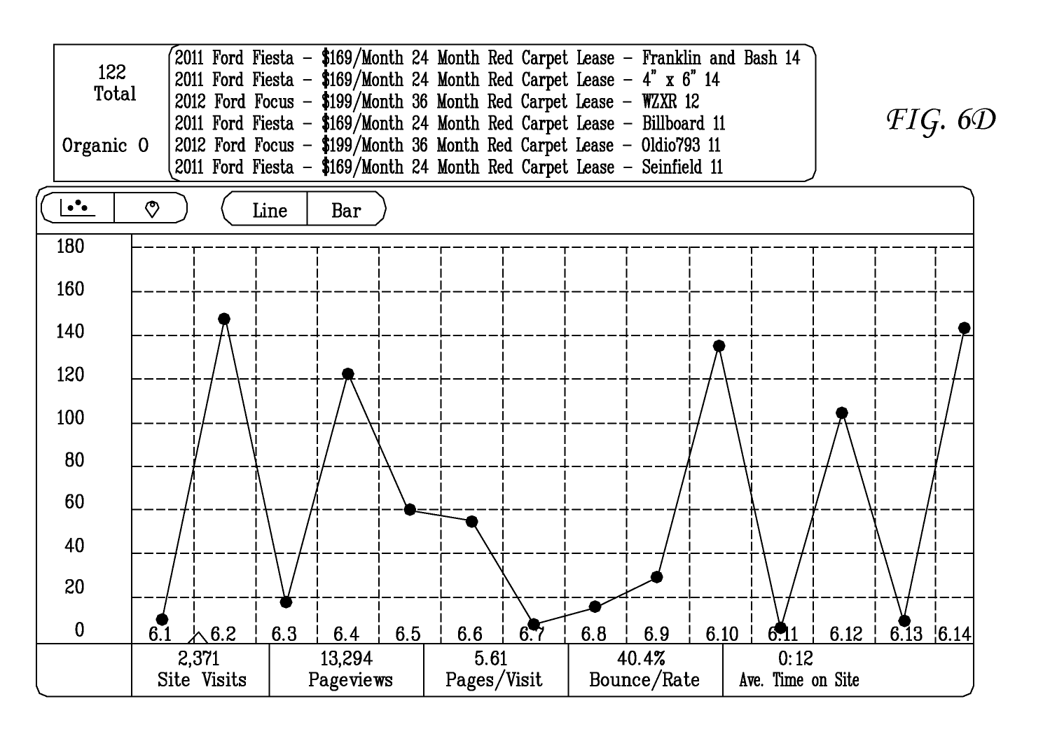

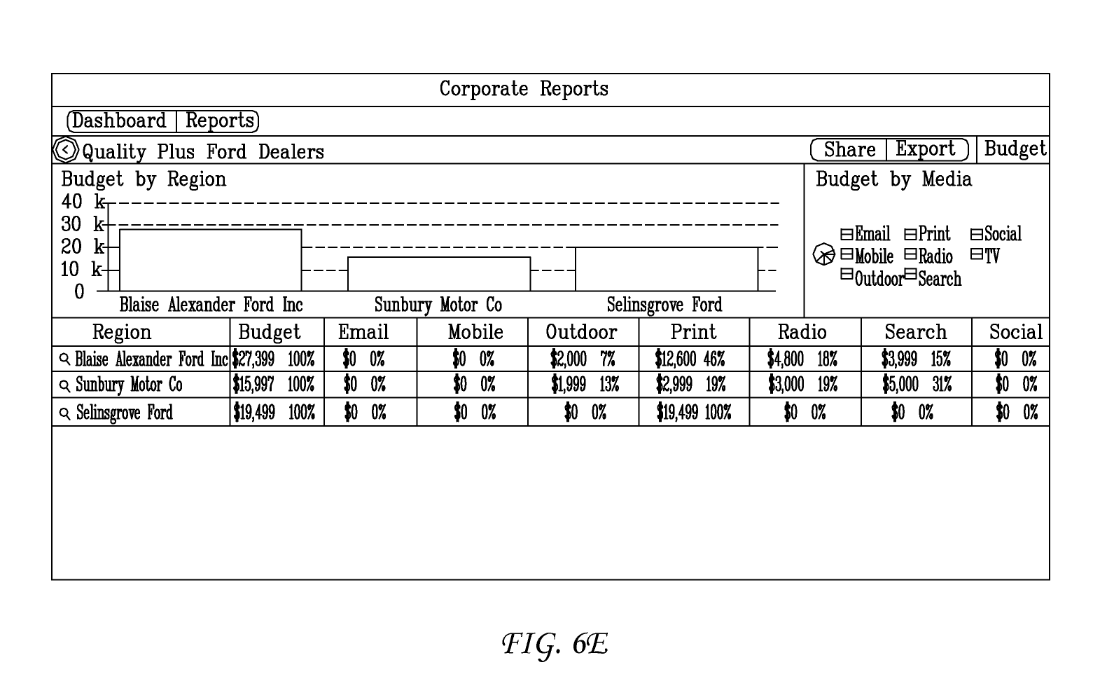

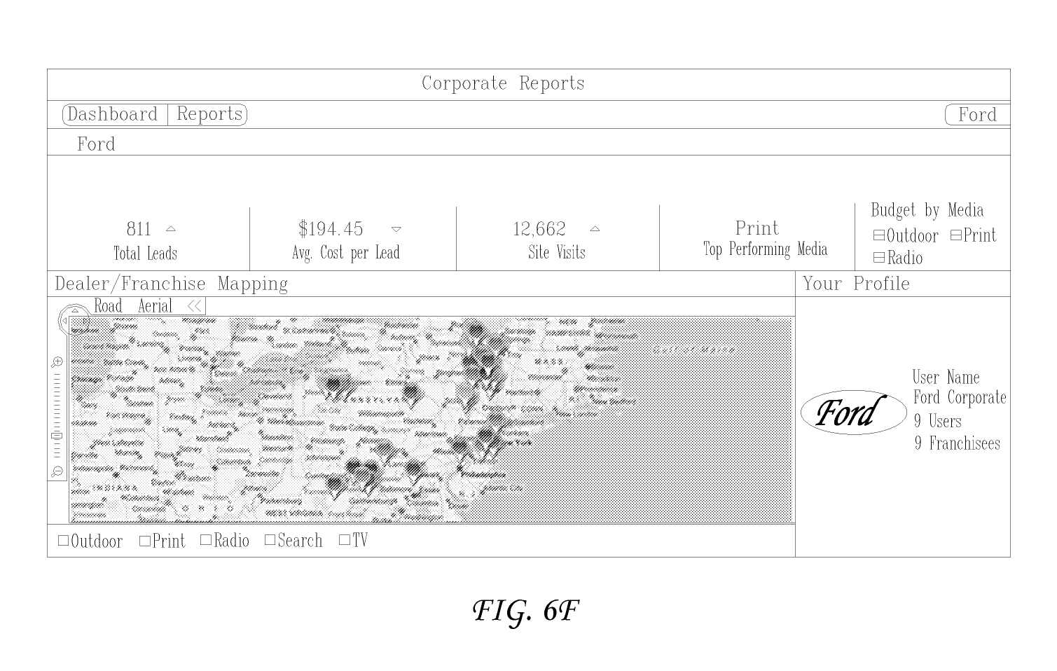

FIGS. 6A-F depict several exemplary reports that may be generated by service 120 in connection with analyzing, compiling, and providing data illustrating the effectiveness of various advertisements. Referring to FIG. 6A, service 120 may generate a report that lists various advertising campaigns. For example in the example report of FIG. 6A, the report identifies advertising campaigns 610, 612, and 614. In the illustrative embodiment, the report has been formatted so as to display the advertisements that have designated as corresponding to one of the particular advertising campaigns 610. The various advertisements that were defined for campaign 610 are displayed by the particular media type, i.e., online, offline (print/radio). Further for each of the advertisements, information about the inputs or leads that had been traced to the particular advertisement are shown. For example, and as illustrated, for each advertisement, the system displays the budget spend on the advertisement, the number of calls generated by the advertisement, the number of forms that were filled out in response to the advertisement. Additionally, the total number of leads, such as, for example, the total number of telephone calls phone numbers and URL that are identified as tracking identifiers, is calculated and displayed. Still further, the average cost per lead is calculated and displayed. The average cost per lead may be calculated by dividing the cost for the particular advertisement by the total number of leads generated by the advertisement. The information presented in the report illustrates the relative effectiveness of the advertisements across media types. For example, the number of calls and/or web accesses may be compared as between advertisements and advertisement media types. Similarly, the average cost per lead for the various advertisements and advertisement media types may be compared. In the example of FIG. 6A, the details relating to the advertisements comprised in advertising campaigns 612 or 614 may be accessed by clicking the particular campaign listing. It should be appreciated that a report such as shown in FIG. 6A may be generated for an organization at any level of an organization structure. Accordingly, and referring to the earlier example scenario, the report may be generated for a particular car dealer, a regional affiliation of car dealers, and/or for a national affiliation of dealerships. Where the report is generated for a hierarchy of organizations, the system aggregates the data so as to report on the appropriate level of the organization. For example, where the system generates a report for regional affiliation of car dealerships, the system aggregates the leads for each of the car dealerships in the affiliation. Likewise the costs associated with the advertisements and leads are aggregated for presentation. Service 120 refers database 210 to retrieve the structure of the organization and to retrieve information regarding the advertisements taken out by the relevant sub-organizations. The service 120 uses this information to perform its aggregation of the data from sub-organizations.

FIG. 6B illustrates another report that may be generated using service 120. As shown in FIG. 6B, the leads corresponding to a particular advertisement or advertising campaign may be displayed in chart form. In the example of FIG. 6B, the leads generated by advertisements of each media type are represented by a bar in a bar chart. In particular, a bar is presented for each of the following advertisement media types: print; radio; TV; Web search; and outdoor. In the particular scenario of FIG. 6B, it is clear that the advertisements placed in print media generated the largest number of leads, more than twice any other media type and several times more than through Web search. It should be appreciated that a report such as shown in FIG. 6B may be generated for an organization at any level of an organization structure. Data is aggregated within an organization as necessary to generate the report at the desired level of the hierarchical organization. While a bar chart is represented in FIG. 6B, any type of chart (bar, pie, etc.) that may allow for display of the relevant information may be used.

FIG. 6C illustrates another report illustrating the relative effectiveness of the advertising media types that may be generated using service 120. FIG. 6C depicts a report breaking down leads or user inputs across time. In the illustrative scenario of FIG. 6C, the report illustrates the leads for each month of a year. The report shows the total number of leads or inputs that were generated as well as the leads by type, i.e., phone call and URL or form accesses. For leads that take the form of calls, additional detailed information may be listed including, for example, an average call length, the media type that generated the highest number of telephone calls, the number of unanswered calls, and the day with the highest number of calls. Still further, the report may illustrate the accesses to URL's resulting from advertisements of various media types. It should be appreciated that a report such as shown in FIG. 6C may be generated for an organization at any level of an organization structure. Data is aggregated within an organization as necessary to generate the report at the desired level of the hierarchical organization.

FIG. 6D is another report illustrating the relative effectiveness of the advertising media types that may be generated using service 120. FIG. 6D depicts a report showing the number of leads, i.e. calls and URL accesses, that were created on each of several days across time. Selecting a data point on the graph provides additional detail regarding the advertisements that the leads for the selected date. In the illustrative example illustrated in FIG. 6D, the several advertisements that resulted in the leads are shown. For each advertisement the number of leads corresponding to the particular advertisement are shown. The media type of the particular advertisements is provided. Accordingly, it is possible to compare the effectiveness of the various advertisements and media types on driving interest at a particular date in time. It should be appreciated that a report such as shown in FIG. 6C may be generated for an organization at any level of an organization structure. Data is rolled up within an organization as necessary to generate the report at the desired level of the hierarchical organization.

FIG. 6E depicts another report that may be generated by service 120. The report depicted in FIG. 6E illustrates advertising budget breakdowns for various different groups within a larger organization. As shown for the example report of FIG. 6E, the advertising budgets and distribution of the budget across various advertising media types, i.e., email, mobile, outdoor, print, etc., are depicted for three car dealers which are part of a larger organization. The relative budgets of the three car dealers may be compared and contrasted. Moreover, the aggregated budget allocation for all three of the car dealers that are depicted and part of a larger organization are also presented in the report.

FIG. 6F depicts another report that may be generated by service 120. In the report of FIG. 6F, the leads have been generated by advertisements are depicted as pushpins on a geographic map. The colors of the pushpins identify the type of advertising media that was responsible for generating the lead. The report also notes the total number of leads, the average cost per lead, and the advertising media type that generated the highest number of leads. Also depicted is the relative budgets across the media types. It should be appreciated that a report such as shown in FIG. 6C may be generated for an organization at any level of an organization structure. Data is rolled up within an organization as necessary to generate the report at the desired level of the hierarchical organization.

Example Computing Environment

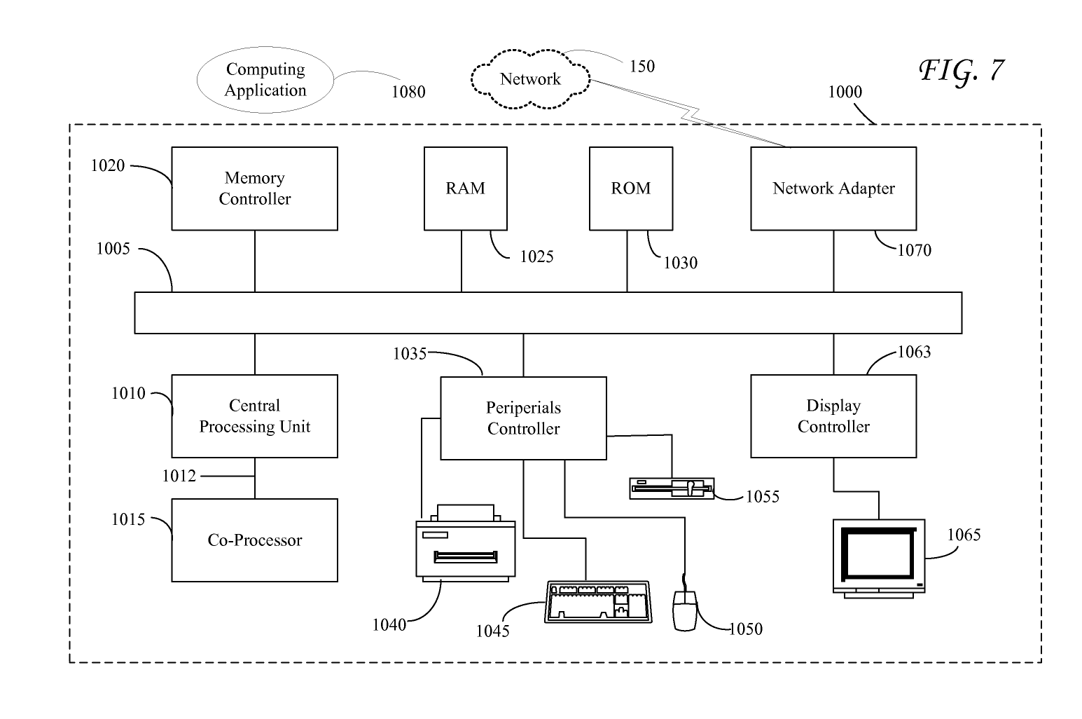

FIG. 7 depicts a block diagram of an exemplary computing system 1000 that may be used to implement the systems and methods described herein. For example, the computing system 1000 may be used to implement the media tracking service 120 as well as any of devices 110a-e. The computing system 1000 may be controlled primarily by computer readable instructions that may be in the form of software. The computer readable instructions may include instructions for the computing system 1000 for storing and accessing computer readable instructions themselves. Such software may be executed within a central processing unit (CPU) 1010 to cause the computing system 1000 to perform the processes or functions associated therewith. In many known computer servers, workstations, personal computers, or the like, the CPU 1010 may be implemented by micro-electronic chips CPUs called microprocessors.

In operation, the CPU 1010 may fetch, decode, and/or execute instructions and may transfer information to and from other resources via a main data-transfer path or a system bus 1005. Such a system bus may connect the components in the computing system 1000 and may define the medium for data exchange. The computing system 1000 may further include memory devices coupled to the system bus 1005. According to an example embodiment, the memory devices may include a random access memory (RAM) 1025 and read only memory (ROM) 1030. The RAM 1025 and ROM 1030 may include circuitry that allows information to be stored and retrieved. In one embodiment, the ROM 1030 may include stored data that cannot be modified. Additionally, data stored in the RAM 1025 typically may be read or changed by CPU 1010 or other hardware devices. Access to the RAM 1025 and/or ROM 1030 may be controlled by a memory controller 1020. The memory controller 1020 may provide an address translation function that translates virtual addresses into physical addresses as instructions are executed.

In addition, the computing system 1000 may include a peripherals controller 1035 that may be responsible for communicating instructions from the CPU 1010 to peripherals, such as, a printer 1040, a keyboard 1045, a mouse 1050, and data a storage drive 1055. The computing system 1000 may further include a display 1065 that may be controlled by a display controller 1063. The display 1065 may be used to display visual output generated by the computing system 1000. Such visual output may include text, graphics, animated graphics, video, or the like. The display controller 1063 may include electronic components that generate a video signal that may be sent to the display 1065. Further, the computing system 1000 may include a network adaptor 1070 that may be used to connect the computing system 2000 to an external communication network such as the network 150, described above in FIG. 1.

Thus, applicants have disclosed exemplary embodiments of systems and methods for tracking advertising media. Advertising campaigns including the advertisements comprised therein may be defined in the system. In an example scenario, a scheduled advertisement is added to the system, perhaps using a calendar. A tracking identifier, which may be a call tracking number, unique URL and/or other unique tracking mechanisms, is assigned to the advertisement. Data regarding the leads that are generated by the advertisements is collected and tracked. The leads may be calls that have been received, forms that have been filled, visitors on website, and other related actions. Thereafter, the relative effectiveness of the advertising media types illustrated in reports. For example, the system allows for listings of media sources to be displayed along with a date of each advertisement and corresponding reporting entities like calls received, forms filled, visitors on website and other related actions. The service also assembles data derived from the various tracking reports to determine various performance indicators, which include advertisements that are the least expensive and most effective on a cost per lead basis and the day of the week that is most effective. The disclosed embodiments to media tracking cross reference website visitors with all advertising mediums both online and traditional. Businesses may accurately manage their advertising expenditures and measure each media's direct effectiveness on brick and mortar sales in concert with website traffic.

It will be appreciated that while illustrative embodiments have been disclosed, the scope of potential embodiments is not limited to those explicitly set out. For example, while the system has been described with reference to systems and methods for particular media types, the envisioned embodiments extend beyond processing of any particular media type. Similarly, any type of user input or lead, beyond telephone calls or URL accesses, that results from an advertisement may be tracked using the disclosed service.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Those skilled in the art will appreciate that the disclosed embodiments may be provided as a subscription web based solution that anyone with an internet connection may log on and begin using the system. Large corporations may internally monitor multiple users within an exemplary embodiment platform to direct media placement. The potential embodiments may be developed and programmed in any web based technology platform. Alternatively, a potential embodiment may be implemented as a stand alone application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, implemented by a computing system, for tracking advertising media, comprising:
assigning a first identifier to a first media type, the first media type associated with an advertising campaign;
assigning a second identifier to a second media type, the second media type associated with the advertising campaign, and at least one of the first media type and the second media type being an off-line media type;
receiving a plurality of inputs, each of the plurality of inputs associated with one of the first identifier and the second identifier;
identifying each of the plurality of inputs associated with the first identifier and storing information identifying a relationship with the first media type for each of the plurality of inputs associated with the first identifier;
identifying each of the plurality of inputs associated with the second identifier and storing information identifying a relationship with the second media type for each of the plurality of inputs associated with the second identifier;
compiling data relating to effectiveness of the first media type and the second media type using the plurality of inputs associated with the first media type and the plurality of inputs associated with the second media type.

2. The method of claim 1, wherein an off-line media type is one of the following:
physical print media; broadcast radio; outdoor media; broadcast television; and cable television.

3. The method of claim 1, wherein each of the first media type and the second media type is one of the following: broadcast media; cable media; radio media; print media; outdoor media; and online media.

4. The method of claim 1, wherein assigning a first identifier to a first media type comprises assigning a first identifier to a first media advertisement scheduled to be made on a particular date.

5. The method of claim 1, wherein assigning a first identifier to a first media type comprises assigning a tracking number to a first media type.

6. The method of claim 5, wherein assigning a tracking number to a first media type comprises assigning a telephone number to a first media type.

7. The method of claim 1, wherein assigning a first identifier to a first media type comprises assigning a web address to a first media type.

8. The method of claim 1, wherein assigning a second identifier to a second media type comprises assigning a second identifier to a second media advertisement scheduled to be made on a particular date.

9. The method of claim 5, wherein assigning a second identifier to a second media type comprises assigning one of a telephone number and a web address to a second media type.

10. The method of claim 7, wherein assigning a second identifier to a second media type comprises assigning one of a telephone number and a web address to a second media type.

11. The method of claim 1, wherein
assigning a first identifier to a first media type comprises assigning a telephone number to a first media type, and
assigning a second identifier to a second media type comprises assigning a web address to a second media type.

12. The method of claim 11, wherein the first media type is print advertisement, and the second media type is broadcast advertisement.

13. The method of claim 10, wherein the first media type and the second media type are different.

14. The method of claim 10, wherein the first media type and the second media type are the same.

15. The method of claim 1, further comprising maintaining a database of identifiers that are available to be assigned to media types.

16. The method of claim 15, wherein maintaining a database of identifiers comprises maintaining telephone call tracking numbers and web page addresses.

17. The method of claim 1, further comprising:
receiving input identifying an entity associated with the advertising campaign;
storing information associating the entity with the advertising campaign;
wherein compiling data comprises retrieving the information associating the entity with the advertising campaign and aggregating data associated with the entity and other entities associated in a hierarchy of organizations.

18. The method of claim 15, wherein assigning a first identifier to a first media type comprises receiving a user input matching an identifier from the database of identifiers to a media type.

19. The method of claim 15, wherein assigning a second identifier to a second media type comprises receiving a user input matching an identifier from the database of identifiers to a media type.

20. The method of claim 1, further comprising receiving user inputs defining an advertising campaign.

21. The method of claim 20, wherein receiving user inputs defining an advertising campaign comprise receiving user inputs identifying media types associated with an advertising campaign.

22. The method of claim 20, further comprising:
receiving user inputs associating the first identifier to the first media type; and
receiving user inputs associating the second identifier to the second media type.

23. The method of claim 1, wherein receiving a plurality of inputs comprises receiving a plurality of inputs that reflect actions taken in response to the first media type and the second media type.

24. The method of claim 1, wherein receiving a plurality of inputs comprises receiving a plurality of inputs that reflect financial data associated with the first media type and the second media type.

25. The method of claim 1, wherein receiving a plurality of inputs comprises receiving a plurality of inputs that reflect sentiment data associated with the first media type and the second media type.

26. The method of claim 1, wherein identifying each of the plurality of inputs associated with the first identifier comprises determining whether the input identifies a particular phone number or a particular web address.

27. The method of claim 1, wherein identifying each of the plurality of inputs associated with the second identifier comprises determining whether the input identifies a particular phone number or a particular web address.

28. The method of claim 1, wherein compiling data relating to effectiveness of the of the first media type and the second media type comprises compiling a number representing a total of user inputs associated with the first identifier and compiling a number representing a total of user inputs associated with the second identifier.

29. The method of claim 28, wherein compiling data relating to effectiveness of the first media type and the second media type further comprises identifying a cost associated with the first media type associated with the advertising campaign, and identifying a cost associated with the second media type associated with the advertising campaign.

30. The method of claim 29, wherein compiling data relating to effectiveness of the first media type and the second media type further comprises compiling a number representing a cost per user input associated with the first media type, and compiling a number representing a cost per user input associated with the second media type.

31. The method of claim 30, wherein compiling data relating to effectiveness of the first media type and the second media type further comprises compiling a number representing a cost per sale associated with the first media type, and compiling a number representing a cost per sale associated with the second media type.

32. The method of claim 1, further comprising assigning the first identifier and the second identifier to a first organization, the first organization related to a plurality of organizations related to each other in a hierarchical structure.

33. The method of claim 32, further comprising compiling data relating to effectiveness of the first media type for the first organization and the plurality of organizations related to each other in a hierarchical structure.

34. The method of claim 1, wherein receiving a plurality of inputs, each of the plurality of inputs associated with one of the first identifier and the second identifier, comprises receiving inputs associated with a telephone number.

35. The method of claim 34, wherein receiving inputs associated with a telephone number comprises receiving data generated from a telephone call to the telephone number.

36. The method of claim 35, wherein receiving data generated from a telephone call to the telephone number comprises receiving one or more of the following: a recording of the telephone call; a location associated with the call; a time and date of the call; and a length of the call.

37. The method of claim 1, wherein receiving a plurality of inputs, each of the plurality of inputs associated with one of the first identifier and the second identifier, comprises receiving inputs associated with a web address.

38. The method of claim 37, wherein receiving inputs associated with a web address comprises receiving web requests to access a web page at a web address.

39. The method of claim 37, wherein receiving inputs associated with a web address comprises receiving data entered into a web form accessed at a web address.

40. A computer-implemented method, comprising:
receiving inputs defining a plurality of advertisements, each of the plurality of advertisements having a tracking identifier, at least one of the plurality of advertisements being an online advertisement and at least one of the plurality of advertisements being an offline advertisement;
receiving data regarding leads generated in response to the plurality of advertisements, each of the leads having an associated tracking identifier;
using tracking identifiers associated with the data regarding leads to correlate the leads to the plurality of advertisements; and
compiling for each of the plurality of advertisements information reflecting the leads correlated with the particular advertisement.

41. The computer-implemented method of claim 40, wherein compiling for each of the plurality of advertisements information reflecting the leads correlated with the particular advertisement comprises compiling for each of the plurality of advertisements the number of leads generated by the particular advertisement.

42. The computer-implemented method of claim 40, further comprising aggregating information reflecting leads for a plurality of organizations in a hierarchy of organizations.
